(19) United States
(12) Patent Application Publication
(10) Pub. No.: US 2026/0158501 A1
(43) Pub. Date: Jun. 11, 2026

(54) SEPARATING APPARATUS FOR SEPARATING A SUSPENSION

(71) Applicant: GEA WESTFALIA SEPARATOR GROUP GMBH, Oelde (DE)

(72) Inventors: Andreas SCHULZ, Beckum (DE); Kai HELMRICH, Drensteinfurt (DE); Kathrin QUITER, Drensteinfurt (DE); Sebastian SPIEKERMANN, Oelde (DE); Steffen LAACKMANN, Wadersloh (DE)

(21) Appl. No.: 19/102,055

(22) PCT Filed: Aug. 7, 2023
(86) PCT No.: PCT/EP2023/071856

§ 371 Date: Feb. 7, 2025

(30) Foreign Application Priority Data
Aug. 10, 2022 (DE) 20 2022 104 551.8
Feb. 10, 2023 (DE) 20 2023 100 651.5

(51) Int. Cl. B04B 11/02; B04B 1/08; B04B 13/00; G01F 23/263; G01F 23/28

(52) U.S. Cl. CPC B04B 11/02; B04B 1/08; B04B 13/00; G01F 23/263; G01F 23/28; B04B 2013/006

(57) ABSTRACT

A separating apparatus for separating a suspension includes a centrifugal separator for reducing cross-contaminations in the processing of products, the centrifugal separator having a frame or a housing and a separator insert mounted rotatably with respect to the frame or housing and forming a preassembled, interchangeable unit. The separating installation has at least one container connected to at least one product-discharge line. The separating apparatus has a filling-level measuring device for determining a liquid level of the suspension within the container and/or at least one limit switch for detecting a liquid level reached within the container.

### BACKGROUND AND SUMMARY OF THE INVENTION

Exemplary embodiments of the invention relate to a separating apparatus for separating a suspension with a disk separator.

Disk separators as described in this document are used to separate a free-flowing suspension as a starting product in a centrifugal field into phases of different densities. Sterility of the product-contacting parts of the separators used is required for a wide range of applications.

The main application of the present invention is in the field of disk separators with so-called interchangeable separator inserts, as they are suitable for single-use applications. Here, in particularly sensitive applications such as biotech applications, but also in pharmaceutical or medical applications, all product-contacting elements should be disposed of after their single use in order to avoid cross-contamination.

One aim of the invention is to maintain the filling level in a container, e.g., a plastic bag or plastic container, which is located in the drain of the light and/or heavy phase in a separating apparatus at a defined filling level so that it neither runs empty nor overflows.

For this purpose, a suitable measuring system and a discharge system must be selected in such a way that it controls the flow of individual product phases, possibly with the aid of a control unit, in such a way that the liquid level in the container can be kept constant even if the inflow into the container fluctuates.

EP 3 885 050 A discloses a device and a method for separating a suspension into several product streams. In a manner known per se in mechanical separation technology, see also WO 2012/125480 A1 and DE 34 30 264 A1, a mass is determined by means of a scale of a product stream derived from the separation device into a container.

It is only possible to keep the liquid level in the container precisely constant by determining the mass using a scale if the density of the separated phase is known.

However, the density of the separated phase can vary. For example, it may contain air bubbles or air pockets and even form a foam phase. As the density varies, the calculation of the filling level in such a container also varies. The suitability of a weighing system for level control is therefore limited.

Against this background, exemplary embodiments of the invention are directed to a separating apparatus with a container in which a liquid level can be maintained at a defined value independently of the medium, i.e., also for media with fluctuating density, so that the container is not overfilled, for example. The filling level is determined directly and not indirectly, e.g., by measuring the weight.

A separating apparatus according to the invention is used for separating a suspension with a centrifugal separator as part of said separating apparatus.

The centrifugal separator has a frame and/or a housing.

Furthermore, the centrifugal separator has a separator insert with a separator insert that is rotatably mounted relative to the frame or the housing as a pre-assembled, interchangeable unit.

The separator insert has at least the following features:
i. a rotor rotatable about an axis of rotation with a drum and a drum wall; Within the drum, the suspension is separated into a light and a heavy phase in the centrifugal field and these are discharged separately. It is also possible that one phase, in particular the heavy phase, remains in the drum and only the light phase is discharged.
ii. preferably a separating means arranged in the drum; Such a separating means can be, for example, a disk pack, which preferably has conical separating disks.
iii. has at least one product-feed line and at least one product-discharge line;

The separator can advantageously also have several product-feed lines and several product-discharge lines. A solids phase can thus be discharged via a separate product-discharge line as part of the separator insert. In this case, all product-feed lines from the drum are part of the feed system and all product-discharge lines from the drum are part of a discharge system.

The entire separator insert with its feed and discharge system is advantageously of a sealed design in relation to the frame or housing. This is particularly preferable for interchangeable single-use applications. The feed system can have several product-feed lines and the discharge system can have several product-discharge lines. A separate product-feed line can be used, for example, to feed flocculant or similar into the suspension. Other substances, e.g., agents for preserving the product during processing, such as ascorbic acid, possibly as a diluted solution, can also be fed in via a separate product-feed line.
iv, wherein the product-contacting areas of the separator insert are partially or completely made of plastic.

For reasons of better recycling, it is recommended or preferred that all components of the separator insert that come into contact with the product are made of plastic. Composite materials, e.g., metal-plastic composites, on the other hand, are more difficult to dispose of.

Furthermore, the separating apparatus has at least one container connected to the at least one product-discharge line. The container preferably has a spatially separate feed and discharge opening.

Finally, the separating apparatus has a filling-level measuring device for determining a liquid level of the suspension within the container and/or at least one or more limit switches for detecting a liquid level reached within the container. Furthermore, the separating apparatus can have a control unit that receives and evaluates the filling-level measuring signals and generates the necessary signals to control one or more drain pumps and/or any optionally necessary valves.

This allows at least a certain filling level to be maintained and, in the case of the measuring device, to be determined continuously or, if required, precisely. This is much more complicated when determining the mass, e.g., by means of scales, of leaking liquid and involves more measurement errors and/or measurement inaccuracies, especially as the determined mass must first be converted into volume or filling level.

It is advantageous if the filling-level measuring device and/or the limit switch is arranged non-invasively on the outside of the container so that no direct contact is made with the product. This avoids surface reactions on the measuring surfaces or the contact surfaces of the sensor element and the like. Non-invasive sensors can also be reused in single-use systems, as only components coming into contact with the product are generally used once. Examples of possible principles for such non-invasive measurements are: capacitive measurement, optical measurement, measurement of the damping of vibration, pressure measurement, measurement of changes in shape or transit time measurement of ultrasonic or radar signals.

The container can have a discharge, e.g., a discharge nozzle, for the continuous drainage of a liquid.

Preferably, the filling-level measuring device and/or the limit switch has a sensor element for emitting and/or receiving an electromagnetic signal, preferably an ultrasonic signal, a microwave signal and/or a light signal. These variants have already proven themselves as non-invasive measurement methods in other areas of application.

The centrifugal separator can also have a drainage of the heavy phase and a drainage of a light phase, preferably each as part of the aforementioned discharge system, with a pump being arranged in at least one of the drains.

The separating apparatus can advantageously have a device for adjusting the filling level in the container. The pump can be part of this device. The same applies to the filling-level measuring device and/or the at least one limit switch. The pump is designed to be adjustable based on the measuring signals from the filling-level measuring device and/or the limit switch. This includes, among other things, a signal connection between the elements, optionally via cable or via wireless transmission to the evaluation unit and/or the control unit.

The filling-level measuring device can be designed to continuously determine the filling level. This can be detected in particular by signal reflection and/or a sudden signal change at a phase boundary.

The filling-level measuring device and/or the at least one limit switch is preferably arranged on the container in an interchangeable manner. This means the measuring device can also be reused when the product-contacting areas are disposed of and is therefore not a single-use component of the separating apparatus according to the invention.

In particular, the filling-level measuring device can be arranged on the container, preferably on its bottom, in such a way that a signal can be transmitted perpendicular to the liquid level. If this is reflected at the liquid level, only one sensor element, which can be switched between transmitting and receiving mode, is required, which simplifies the design of the apparatus.

Alternatively, the separating apparatus for regulating the filling level in a defined filling area in the container can have at least two limit switches for detecting a lower and an upper filling level. These can, for example, be directed at the side of the container from the outside or be in contact with the container. If the upper filling level is exceeded, this is detected by the control unit and a corresponding signal is sent to the drain pump, for example. This is then switched on until the level falls below the lower filling level again. In this way, the filling level can be maintained between the lower and upper filling levels.

If additional measuring points are installed between the lower and upper filling levels, the control unit can also determine the speed at which the bag fills or empties, for example.

The device for adjusting the discharge volume can optionally have a pressure sensor for determining the positional pressure of the liquid in the container, which is preferably arranged at the bottom of the container and/or at a discharge of the container. The pressure sensor also makes it possible to determine the filling level, as there is a correlation between the height of the liquid column in the container and the pressure generated by this.

The filling-level measuring device and/or the limit switch(es) can advantageously have an ultrasonic sensor element and an evaluation unit, which is set up to monitor the suspension composition by comparing a determined sonic velocity with a medium-specific setpoint value of a sonic velocity. It is known that the signal velocity correlates with the composition in the medium. In the case of a known measuring medium with a fluctuating composition of the individual components or in the case of foam formation or air inclusions, a determination can be made by comparing and, optionally, interpolating several ultrasonic values for different compositions. While a clear signal change thus indicates a phase boundary surface, the precise evaluation of the signal velocity at least enables monitoring of whether the respective derived light and/or heavy phase has a constant composition or not. Optionally, not only a monitoring but also a determination of the composition of simple mixtures can be carried out.

In particular, the aforementioned evaluation unit is set up to continuously determine a filling level using the runtime method. For this purpose, the evaluation unit can have a data memory on which a corresponding computer program product is stored.

Alternatively, a capacitive change can also be detected by the measuring arrangement. For this purpose, the sensor for measuring the capacitive change is mounted from the outside at a distance of a few millimeters from the container or brought into contact with the container. If the container contents cover the measuring point, the value of the capacitive coupling changes, which is determined by an evaluation unit and, optionally, forwarded to a control unit as a measuring signal. Analogous to the embodiment variant described above, several capacitive sensors can be used to keep the filling level in the container within a defined level.

By comparing the empty state of the container, it is first possible to determine how the capacitive container properties are formed in the unfilled state.

If the capacitive properties change as a result of filling, a signal is output. Modern capacitive sensors make it possible to suppress drops adhering to the container wall, which can perturb the display of the filling status when it is emptied. Such a suppression of drops can be realized by a full adjustment. Corresponding electronic operating concepts are offered by IFM and other manufacturers.

### BRIEF DESCRIPTION OF THE DRAWING FIGURES

In the following, the invention is described in more detail with reference to the drawing by means of exemplary embodiments, wherein further advantageous variants and designs are also discussed. It should be emphasized that the exemplary embodiments discussed below are not intended to describe the invention exhaustively, but that variants and equivalents not shown are also feasible and fall within the scope of the claims, wherein:

FIG. 1 shows a schematic, sectional representation of a first interchangeable separator insert of a separator, together with a schematic representation of a feed and discharge system and a control unit of the separator;

FIG. 2 shows a schematic, sectional representation of a second interchangeable separator insert of a separator, together with a schematic view of a feed and discharge system and a control unit of the separator;

FIG. 3 shows a schematic representation of a centrifugal separator with a reusable frame and an interchangeable separator insert, the latter here in the manner of FIG. 1, with hose sections arranged thereon;

FIG. 4 shows a perspective view of the interchangeable separator insert from FIGS. 1 and 3 with hose sections arranged on it;

FIGS. 5-7 show three successive steps when inserting the interchangeable separator insert of FIG. 4 into the frame of FIG. 3;

FIG. 8 shows a perspective view of a modification of the separator and the separator insert of FIGS. 1-7 as a further exemplary embodiment;

FIGS. 9a-9c shows a schematic representation of a separating apparatus according to the invention for carrying out a preferred separation process;

FIG. 10 shows a perspective view of a separator insert in a modification of the variants of FIGS. 1-8 with an integrated drainage discharge line; and

FIG. 11 shows another embodiment variant with a rotor as separator insert and a housing as a fixed, non-interchangeable component of the separator;

FIG. 12 a further embodiment variant of a separator insert, which has at least one connection piece on its housing for the supply or discharge of gas.

### DETAILED DESCRIPTION

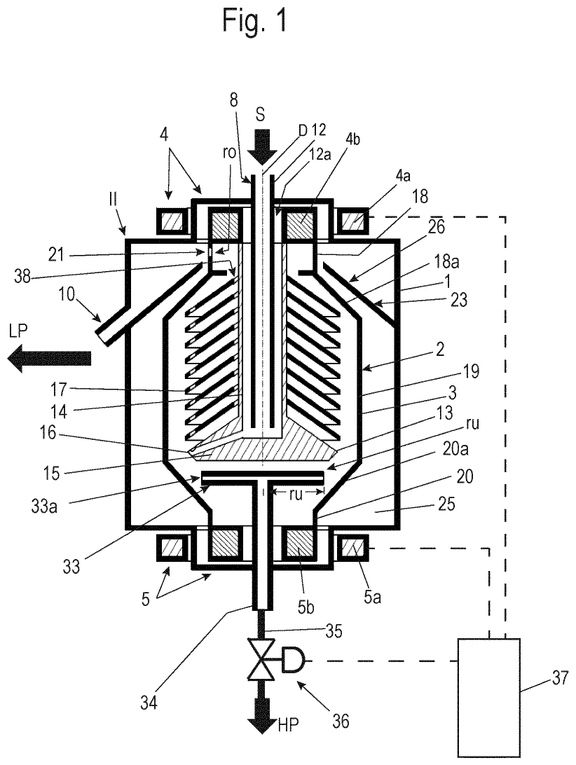

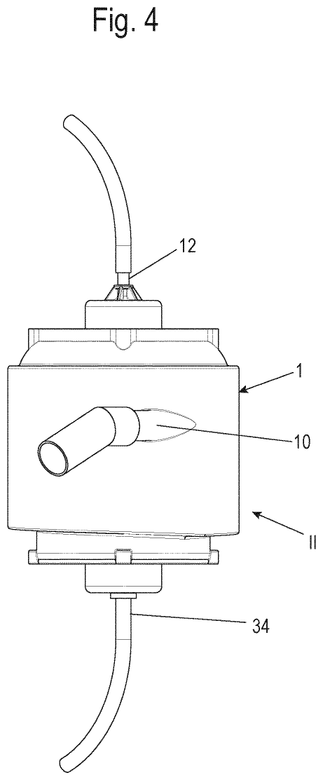

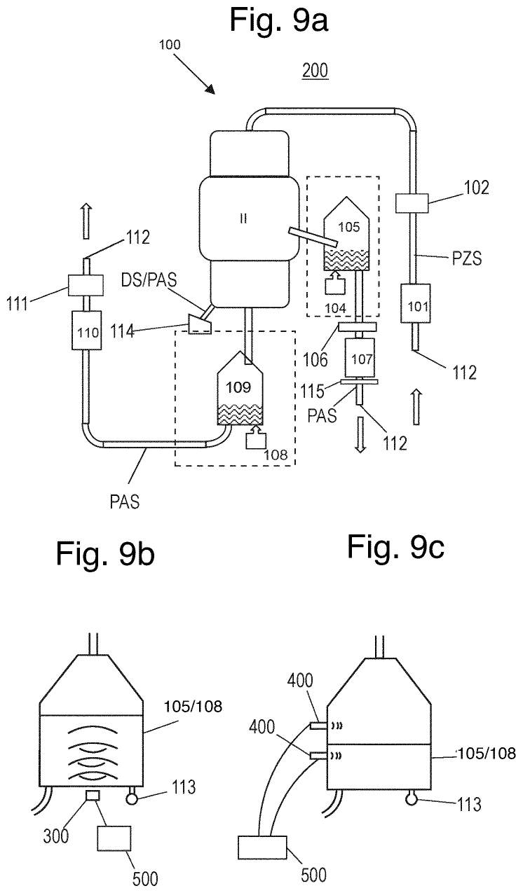

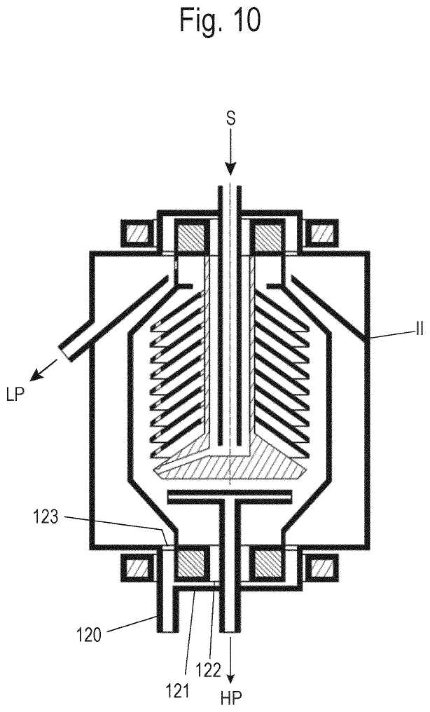

FIGS. 1-12 show several centrifugal separators 100 with a multiply reusable frame I and with an interchangeable separator insert II for centrifugal separation. The separation process can be realized in particular by the embodiment variants of FIGS. 10-12, in which a drainage discharge line 120 is provided. A separating apparatus 200 according to the invention is shown in FIGS. 9a-9c.

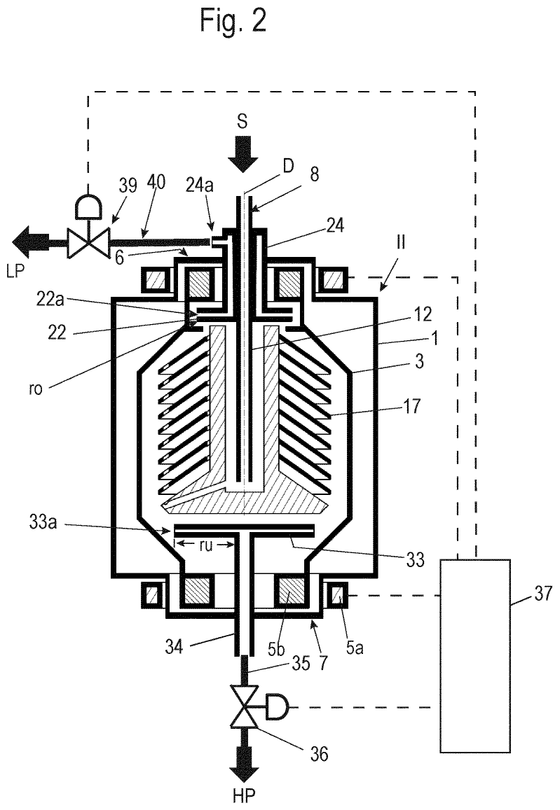

In principle, the separator insert could also be designed as shown in FIG. 1 or FIG. 2 and, optionally, supplemented by a drainage discharge line that is not shown.

The separator insert II is preferably designed as a prefabricated unit. In particular, the separator insert II is designed as a disposable separator insert that can be exchanged or replaced as a whole and is designed as a pre-assembled unit, which is made entirely or predominantly of plastic or plastic composites.

The separator insert (which does not include elements 4a and 5a) is shown separately as an example in FIGS. 1 and 2. It can be disposed of after processing a product batch and replaced with a new separator insert II.

According to FIGS. 1 and 2, the separator insert II of the separator has a housing 1 and the rotor 2, which is inserted into the housing 1 and can rotate relative to the housing 1 during operation. The rotor 2 has an axis of rotation D. This can be aligned vertically, which corresponds to the structure of the frame I. However, it can also be aligned differently in space if the frame is also designed accordingly.

The rotor 2 of the separator insert II has a rotatable drum 3. The rotor 2 is rotatably mounted at two locations axially spaced apart from each other in the direction of the axis of rotation with respective magnetic bearing devices 4, 5. Preferably, the rotor 2 or the drum 3 is rotatably mounted at both axial ends. The separator insert II has rotor units 4b, 5b of the magnetic bearing devices 4, 5. On the other hand, stator units 4a, 5a of the magnetic bearing devices 4, 5 are arranged on the frame I-1.

The magnetic bearing devices 4, 5 preferably act radially and axially and preferably keep the rotatably mounted rotor 2 suspended in the housing 1 at a distance from it.

Such a separator with an easily interchangeable separator insert can be useful and advantageous when processing products where it can be ruled out with a very high degree of certainty that impurities will be introduced into the product-a flowable suspension or its phases-during centrifugal processing or where cleaning and disinfecting the separator would be very time-consuming or not possible at all.

The frame I has a bracket I-1. This can-but does not have to-be mounted on a carriage I-2 with rollers I-3. Receptacles I-4 and I-5 can be formed on the bracket I-1, which serve to accommodate and hold the separator insert II, even during operation. Preferably, a first axial end of the separator insert II projects from below into or towards the upper receptacle I-4 and a lower end of the separator insert II projects from above into or towards the other receptacle I-5, and the separator insert II is held non-rotatably on the bracket I-1 and thus on the frame I.

One or both of the receptacles I-4 and/or I-5 can be arranged laterally on the frame I, in particular the bracket I-1. According to one variant, it may be further provided that, for example, the lower receptacle I-5 is designed to be stationary on the bracket I-1. It is then advantageous that the further upper receptacle I-4 is designed to be height-adjustable on the bracket I-1.

In this case, it is advantageous if the bracket I-1 has such a vertical extension/length that the separator insert is held stationary in a first position of the height-adjustable receptacle I-4 by both height-adjustable receptacles I-4, I-5 and can be changed in the other upper position.

It is advantageously provided that the receptacles I-4 and I-5 with the stator units 4a, 5a on the frame I can be moved axially apart and towards each other again in order to change the separator insert II, i.e., in order to be able to remove the old separator insert II from the frame I and replace it with a new one. This can be realized, for example, with a rail on the bracket and a slide on the height-adjustable receptacle that can be moved and locked in a sliding position (not shown in detail).

It is thus provided that the relative distance between the receptacles I-4 and I-5 with the stator units 4a, 4b of the bearing devices 4, 5 can be adjusted in order to be able to change the separator insert II.

The respective stator units 4a, 5a of two drive and magnetic bearing devices 4 and 5 can be arranged in the respective receptacles I-4 and I-5. The control and power electronics for this can be arranged in or on the frame I, e.g., in, at or on the bracket I-1.

Corresponding positive locking means can be formed on the receptacles I-4 and I-5 and on a housing 1 of the separator insert II, which does not rotate during operation, in order to be able to insert the separator insert II into the stator units 4a, 5a in a rotationally fixed manner. The upper and lower stator units 4a, 5a can each have aligned axes.

According to a particularly simple variant, the housing 1 and the receptacles I-4 or I-5 with the stator units 4a, 5a can have projections (e.g., pins or webs) and recesses (e.g., holes) as the corresponding positive locking means in order to hold the housing 1 non-rotatably on the stator units and thus on the frame II. The corresponding positive locking means can also be formed directly on the frame II.

The position of these corresponding positive locking means also defines the functionally required position of the stator units 4a, 5a and the rotor units 4b, 5b in relation to each other. This applies in particular to the precise centering of the units 4a, 5a and 4b, 5b, which lie coaxially one inside the other. A retaining force (from above and below) can also be exerted on the housing optionally in the axial direction by the receptacles in order to optionally hold it in a force-locking manner.

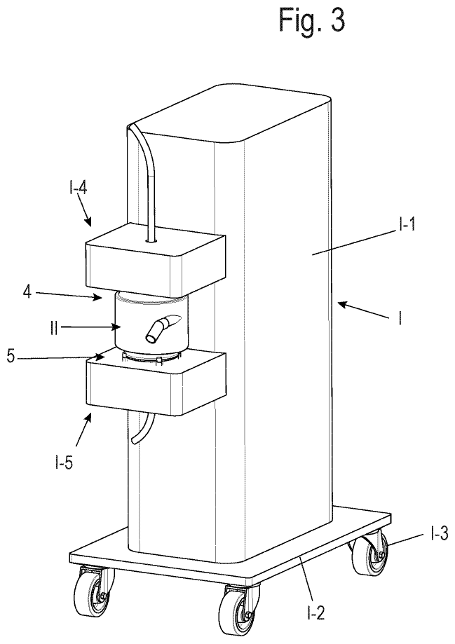

According to FIGS. 3 to 7, the above measures are implemented as follows by way of example.

The receptacles I-4 and I-5 with the stator units 4a, 5a of the frame I each have several pins 41a projecting in the axial direction, and the respective separator insert II can have corresponding blind holes on the housing 1, for example extending in the axial direction, as recesses 42 or 41b.

Here, the receptacle I-4 with the stator unit 4a has axially or here vertically downwardly projecting pins 41 (not to be seen here) and the separator insert II has vertically upwardly corresponding blind hole-like recesses 42 (to be seen here) and the lower receptacle I-5 with the lower stator unit 5a has correspondingly axially or here vertically upwardly projecting pins 41a (to be seen here) and the separator insert II has axially downwardly corresponding blind hole-like recesses (not to be seen here). Purely by way of example, four pins 41a and recesses 41b are each arranged distributed on the corners of an imaginary polygon, in particular a square, and are formed at the top and bottom of the receptacles I-4, I-5 and the housing 1 of the separator insert II.

In FIGS. 1-7, corresponding positive locking means 41a, 41b and 42 are arranged circumferentially distributed around the separator insert II. However, it is also possible that only one positive locking means is provided instead of several positive locking means.

However, the corresponding positive locking means can also be arranged asymmetrically to ensure that the separator insert can only be used in a single orientation.

The stator units 4a, 5a can each have openings, in particular through-openings 43, in order to accommodate lines such as hoses 44, 45 connected to the separator insert II at the top and/or bottom.

One or both receptacles I-4 and I-5 is/are designed to be vertically adjustable. One of the two receptacles I-4 or I-5 can therefore also be fixed to the frame I. It is therefore also conceivable that one of the two receptacles I-4 or I-5—e.g., the lower one-is formed on a wall of the frame I and is non-adjustable. It is then sufficient to design the frame I in such a way that the respective other receptacles I-4 or I-5 are adjustable, in particular are arranged and/or designed to be vertically height-adjustable on the frame I.

This can be clearly seen from the interaction of FIGS. 3 to 7.

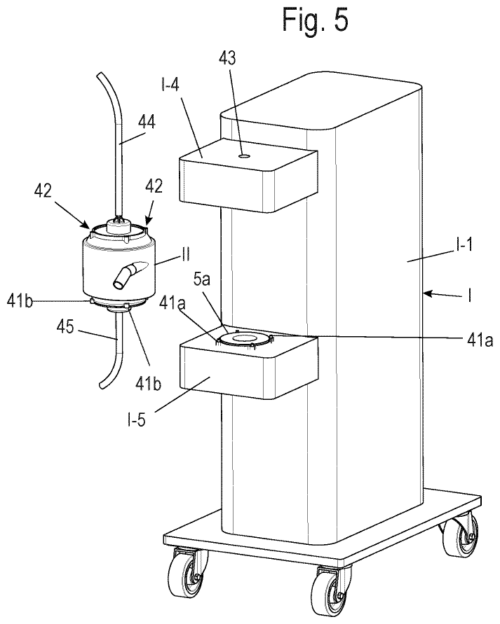

FIG. 5 shows the frame I before inserting a separator insert II.

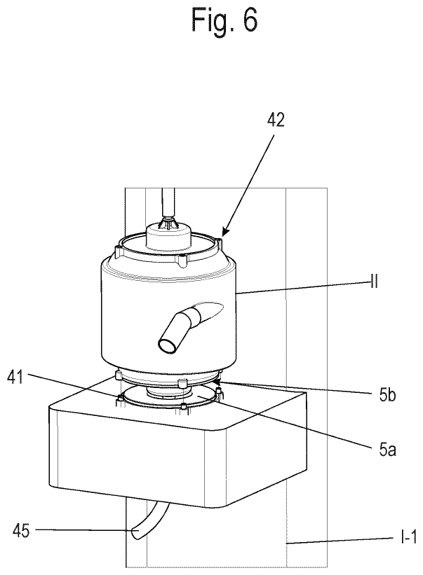

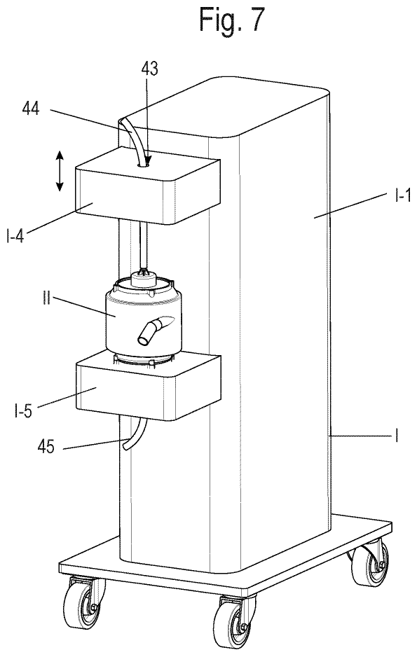

The two stator units 4a, 5a have been moved so far apart relative to each other that the respective separator insert can be lifted axially between the two receptacles with the stator units 4a, 5a (FIGS. 5, 6), wherein the separator insert II is then placed in/on the lower receptacle I-5 (FIGS. 6 and 7) in such a way that the corresponding positive locking means—here 41, 42—engage with each other. In addition, the hose 45 at the lower end of the housing 1 has been guided downwards through the through-opening 43 of the lower—and thus axially associated-stator unit 5a (FIG. 6). Now the upper receptacle I-4 is lowered until the corresponding positive locking means of the upper receptacle I-4 and the housing 1 of the separator insert I-here 41, 42—also engage securely with each other (FIG. 7). The upper hoses 44 on the housing 1 are guided through the through-opening 43 of the upper receptacle I-4. The separator insert II is now held securely on the frame I so that it cannot rotate. The centrifuging and separating process for processing a product batch in the centrifugal field can therefore begin. After the intended batch has been processed, the upper separator unit is lifted upwards again until the separator unit can be lifted out of the frame I and replaced with a new one.

With reference to FIG. 1 and FIG. 2, the further structure of exemplary preferred separator inserts II together with the structure of the drive and bearing system of the separator, the control unit of the separator and the feed and discharge system of the separator are described in more detail below. The invention is not limited to this. In particular, the supply and drainage lines can also be realized differently on the separator insert II.

Firstly, the rotor units 4b, 5b can be designed essentially in the manner of inner rings of magnets, in particular permanent magnets, and the interchangeable stator units 4a, 5a, can be designed essentially in the manner of outer rings, which are used for the axial and radial mounting of the rotor 2 (e.g., at the top) or alternatively also for the rotary drive (e.g., at the bottom).

As part of the separator drive, the rotor units 4b and/or 5b therefore also form part of the rotating system or rotor. In other words, the rotor of the drive is part of the drum of the centrifugal separator.

One or both of the magnetic bearing devices 4, 5 is/are thus preferably also used as a drive device for rotating the rotor 2 with the drum 3 in the housing 1. In this case, the respective magnetic bearing device forms a combined magnetic bearing and drive device. The magnetic bearing devices 4, 5 can be designed as axial and/or radial bearings, which support the drum 3 axially and radially at its ends in an overall interacting manner during operation and hold and rotate it in a floating manner overall during operation.

The magnetic bearing devices 4 and 5 can have the same or largely the same basic design. In particular, only one of the two magnetic bearing devices 4, 5 can also be used as a drive device. Corresponding components of the magnetic bearings 4, 5 are thus formed on the separator insert II—on its rotor 2—and other corresponding parts on the frame I. One or both stator units 4a, 5a can also be electrically connected to control and power electronics for controlling the electromagnetic components of the magnetic bearing devices.

The respective magnetic bearing device 4, 5 can, for example, work according to a combined electro-magnetic and permanent-magnetic operating principle.

Preferably, at least the lower axially acting magnetic bearing device 5 serves to keep the rotor 2 axially suspended within the housing 1 by levitation. It can have one or more first permanent magnets, for example on the underside of the rotor, and can also have electromagnets on a receptacle on the frame, which coaxially surround the permanent magnet(s). The rotor can be driven electromagnetically. However, a drive via rotating permanent magnets can also be realized.

Such bearing and drive devices are used, for example, by the company Levitronix for driving centrifugal pumps (EP2 273 124 B1). They can also be used in the context of this document. For example, a first Levitronix motor “bottom” can be used as the drive, which also supports the drum magnetically radially and axially. In addition, a second Levitronix motor-identical in construction except for the control unit during operation, for example—can be provided, which, as the magnetic bearing 4, can support the rotor 2 radially and axially at the head.

The rotor speed can be variably adjusted with the aid of a control device 37 (see FIG. 1 or 2) or a separate control device for the magnetic bearings 4, 5. The direction of rotation of the rotor 2 can also be specified and changed in this way.

During operation, the rotor 2 rotates, keeping it axially suspended and radially centered. Preferably, the rotor 2 with the drum 3 is operated at a speed of between 1,000, preferably 5,000 to 10,000, possibly also up to 20,000 revolutions per minute. The centrifugal forces resulting from the rotation lead to the separation of a suspension to be processed into different flowable phases LP, HP of different densities, as described above, and to their drainage, as described in more detail below. The product batch is processed in continuous operation, which means that the phases separated from the suspension are completely discharged from the drum during operation.

This makes it very possible to create a separator insert and housing for a separator that can be designed for single-use overall, which in turn is of particular interest and advantage for the processing of pharmaceutical products such as fermentation broths or the like, since no cleaning of the drum has to be carried out after operation for processing a corresponding product batch in preferably continuous operation during the processing of the product batch, since the entire separator insert can be replaced. Optionally, individual elements such as magnets can be suitably recycled (see also DE 10 2017 128 027 A1).

The housing 1 is preferably made of a plastic or plastic composite material. The housing 1 can be cylindrical and have a cylindrical outer casing, at the ends of which two radially extending boundary walls 6, 7 (cover and bottom) are formed.

The drum 3 is used for centrifugal separation of a flowable suspension S in the centrifugal field into at least two phases LP, HP of different densities, which can be, for example, a lighter liquid phase and a heavy solid phase or a heavy liquid phase.

In a preferred design, the rotor 2 and its drum 3 have a vertical axis of rotation D. However, the housing 1 and the rotor 2 could also be aligned differently in space. The following description refers to the illustrated vertical alignment (FIG. 3). If the orientation in space is different, the alignments change in accordance with the new orientation. In addition, one or both outlets—still to be discussed—may be arranged differently.

The rotor 2 of the separator with the drum 3 preferably consists entirely or predominantly of a plastic or plastic composite material.

The drum 3 is preferably cylindrical and/or conical, at least in sections. The same applies to the other elements in the rotor 2 and on the housing 1 (except for elements of the magnetic bearing devices 4, 5).

The housing 1 is designed like a container, which is advantageously hermetically sealed except for a few openings/opening areas (to be discussed).

According to FIGS. 1 and 2, one of the openings is formed in each of the two axial boundary walls 6, 7, which are located at the top and bottom of the container 1 in this example.

One of the openings-in the first, here upper axial boundary wall 6—enables or serves as an inlet 8 for feeding a suspension to be separated in the centrifugal field into at least two phases of different density—LP and HP—through the housing 1 into the drum 3.

Here, the first phase is a lighter phase LP and the second phase is a denser, heavier phase HP compared to the first phase.

A second of the openings—in the second, here lower axial boundary wall 7—allows or serves as an outlet for the second heavier phase HP directly from the drum 3 through the housing 1.

The drum 3 also has openings that are assigned to the openings of the housing.

A feed pipe 12 for a suspension to be processed extends into an upper opening 12a at one axial end of the drum 3. This passes through the housing 1, in particular its one-here upper-axial boundary wall 6. On the outer circumference, the feed pipe 12 is sealed towards the housing 1 according to FIG. 1 and inserted into the latter—e.g. by welding or gluing—or, optionally, designed as a single piece with the housing as a plastic injection-molded part. It is preferably also made of plastic. One end of the feed pipe 12 protrudes outwards from the top of the housing 1 and extends through the upper boundary wall 6 into the drum 3 without touching the drum 3.

According to FIG. 1 (but also FIG. 2), the feed pipe 12 passes through the housing 1 and the one magnetic bearing 4 concentrically to the axis of rotation of the rotor 2, then extends axially further inside the housing 1 into the rotatable drum 3 and ends there with its other end-a free outlet end.

According to FIGS. 1 and 2, the feed pipe 12 opens into the drum 3 in a distributor 13 that can rotate with the drum 3. The distributor 13 has a tubular distributor shaft 14 and a distributor foot 15. One or more distributor channels 16 are formed in the distributor foot 15. A stack of separating disks, in this case conical separating disks 17, can be placed on the distributor 13. The distributor 13 and the separating disks 17 are preferably also made of plastic.

In addition, according to both FIG. 1 and FIG. 2, a first paring disk 33 is used to discharge the heavier phase HP of the two phases HP and LP from the drum 3. A paring disk shaft or a central discharge pipe 34 passes through the second axial boundary wall 7 (see FIG. 1 and FIG. 2).

According to one possible-but not mandatory-design, the drum 3 has at least two cylindrical sections 18, 19 of different diameters. Adjacent to these, one or more conical transition areas can be formed on the drum 3. The drum 3 can also have a single or double conical design on the inside of its central axial area (not shown here).

As shown, the drum 3 can have a lower cylindrical section 20 of smaller diameter, on/in which the rotor unit 5b of the lower magnetic bearing is also formed, which merges into a conical section 20a, then here, for example, a cylindrical section 19 of larger diameter, then again a conical section 18a and then an upper cylindrical section 18 of smaller diameter, on which the rotor unit 4b of the upper magnetic bearing 4 is formed.

The separator inserts in FIGS. 1 and 2 differ with regard to the drainage of the lighter phase.

Openings (which can be provided on the drum 3 in a circumferentially distributed manner, wherein several openings can thus be provided on the drum 3 in each case) serve as radial or tangential outlets 21 of the light phase LP from the drum 3 according to FIG. 1. An opening in the outer casing then enables the outlet or serves as discharge 10 of the lighter product phase LP, which is formed during the centrifugal separation and has been discharged from the drum 3, according to the exemplary embodiment of FIG. 1.

The first outlets 21 on the radius ro of the drum 3 are designed in particular as “nozzle-like” openings in the outer casing of the drum 3. They are also designed as so-called “free” discharges from the drum 3. The first outlets 21 are used to discharge the lighter phase LP. The outlets can be designed so that the light phase exits radially or, alternatively, so that the light phase exits tangentially against the direction of rotation of the drum and thus contributes to driving the rotor and reducing the drive energy. This phase emerging from the drum 3 is collected in the housing 1 in an upper catch ring chamber 23 of the housing 1. This catch ring chamber 23 is designed in such a way that the phase caught in it is directed to the discharge 10 of the catch ring chamber 23. This can be achieved by the discharge 10 being located at the lowest point of the catch ring chamber 23. The catch ring chamber 23 is open radially inwards towards the rotating drum 3 and is spaced at such a distance that liquid spraying out of the respective outlet 21 is essentially only sprayed into the associated catch ring chamber 23—which is at the same axial level—during centrifugal separation.

A chamber 25 that is not used to drain a phase can optionally be formed below the catch ring chamber 23. This chamber 25 can optionally have a leakage drain (not shown here). The leakage can run off freely. However, it can also be extracted by negative pressure if the chamber 25 has a negative pressure connection for connecting a device that generates negative pressure.

The first catch ring chamber 23 and the chamber 25 can be separated from one another by a first wall 26, which is conical here and which, starting from the outer casing of the housing 1, extends conically inwards and upwards and ends radially in front of the drum 3 at an internal distance from the latter.

Preferably at the lowest point of the catch ring chamber, the product phase LP is discharged from the housing 1 through the discharge 10. Connecting pieces can be provided on the outside of the housing 1 in the area of the discharge 10 in order to be able to easily connect lines, hoses and the like.

These can in turn be formed directly on the housing 1 or attached to it with adhesive. The connecting pieces are preferably also made of plastic. The housing 1 can be made up of several plastic parts that are sealed together, for example by adhesive or welding.

As the (here second) outlet for the heavier phase HP from the drum (through the housing 1), the first paring disk 33 is provided according to FIGS. 1 and 2, which extends essentially radially and merges into an axially extending drain pipe 34 as a paring disk shaft that passes through the lower axial boundary wall 7 of the housing 1. The paring disk 33 has an outer diameter ru. Here, ru>ro applies. The inlet openings 33a of the paring disk 33 are therefore on a larger diameter or radius ru than the outlets 21 for the light phase LP on the radius ro. This makes it possible to use the paring disk 33 to discharge a heavier phase HP from the drum 3 relative to the lighter phase LP. The paring disk 33 is stationary during operation of the separator and dips with its outer edge into the heavier phase HP rotating in the drum 3.

The phase HP is discharged inwards through the channels in the paring disk 33. The paring disk 33 thus serves to drain the phase HP in the manner of a centripetal pump.

The paring disk 33 can be arranged in a simple and compact manner in the drum 3 below the distributor 14 and below the disk pack 17. The radius ru corresponds to the immersion depth of the paring disk 33.

One end of the drainage pipe 34 is led out of the housing 1 downwards out of the drum and through the lower boundary wall 7, although it does not touch the drum 3. The drainage pipe 34 can be formed in one piece with the housing 1 or inserted into it in a sealed manner. A hose or the like can be connected to the discharge pipe as a drain 35.

The drainage pipe passes through the housing 1 and the lower magnetic bearing 5 concentrically to the axis of rotation D of the rotor 2, and then extends axially further inside the housing 1 into the paring disk 33.

It may be provided that a controllable, in particular electrically controllable, control valve 36 is inserted in the outlet for the heavy phase HP, in particular in the drain 35 for the heavier phase HP. The control valve 36 can be used to throttle the volume flow of the heavy phase HP in the drain 35 and to increase the immersion depth of the associated paring disk. A control device 37 is preferably provided. The control valve 36 is preferably connected to the control device 37 wirelessly or by wire.

The control device 37 can also be designed and provided for controlling the magnetic bearings 4, 5 and the drive.

According to FIG. 2, the light phase LP is also discharged via a paring disk.

For this purpose, a paring disk 22 is provided in the upper area of the drum 3, the inlet openings 22a of which can in turn be located at a smaller radius ro than the radius ru of the inlet of the first-lower-paring disk 33 for the heavier phase.

The shaft of this paring disk 22 can surround the feed pipe 8 like an outer drain pipe 24 and be tightly connected to the housing 1 instead of the feed pipe 8 or be formed integrally with it. The drain pipes 24, 34 of the two paring disks 22, 33 are thus led out of the drum 3 at opposite ends of the latter according to FIG. 2. They are also led out of the housing 1 at opposite ends of the latter. They can be inserted into the housing 1 in a sealed manner. However, they can also be made in one piece from plastic. The feed pipe 12 can be connected to the upper end of the paring disk shaft 24. A radial or tangential connecting piece 24a can lead out of the paring disk shaft 24. A drain 40 for draining the light phase can be connected to this, which can lead into a product collection container, e.g. into a bag or tank or the like. Accordingly, the ends of the pipes 12 and 34 can also be designed as nozzles for connecting hoses or the like (FIG. 2, but also FIG. 1).

It may be provided that a controllable, in particular electrically controllable, control valve 39 is also installed in the drain 40 for the light phase LP.

The control valve 39 can be used to change the volume flow of the light phase LP, in particular to throttle it more or less and thus change the immersion depth of the second paring disk 22. The control valve 39 is also connected to the control device 37 wirelessly or by wire, so that it can be controlled by the control device 37.

The respective paring disk 22, 33 is in each case a cylindrical and essentially radially aligned disk provided with several, for example one to six, channels, which is stationary during operation and has channels, so that a type of centripetal pump is formed. The outer edge of the respective paring disk 22 or 33 is immersed in the phase LP or HP rotating in the separator. The respective phase LP, HP is diverted inwards through the channels in the paring disk and the rotational speed of the respective phase LP, HP is converted into pressure. The respective paring disk 22, 33 thus replaces a drain pump for the respective phase LP, HP. The paring disks thus each work as a centripetal pump. They can be made of plastic.

Theoretically, a third paring disk could also be provided, which could be used to discharge a further phase.

The operation of the separators according to FIG. 1 and then FIG. 2 is briefly described below.

First, the respective separator is provided with its reusable components or reusable components. This includes the frame I as well as the drive and stator units 4a, 5a of the magnetic bearing devices. This also includes a control unit 37. A separator insert II is then provided and mounted on the frame I. For this purpose, only the stator units 4a and 5a need to be moved apart. The separator insert is then inserted with a positive fit and the stator units are moved towards each other. This ensures that the housing is held securely against rotation. Now, optionally, hoses are connected to the nozzles that lead into containers or bags. The respective separator insert of FIGS. 1 and 2 can therefore preferably also have at least hoses and nozzles that can be connected to other lines (not shown here) and containers such as bags, tanks, pumps and the like.

Then, after connecting the pipes and hoses and the like, a suspension is fed into the rotating drum (inlet 8), where it is separated centrifugally into the light phase LP and the heavy phase HP.

The heavier phase HP of greater density flows radially outwards in the drum 3 in the separation chamber. There, the phase HP leaves the drum on a radius ru through the channels of the stationary paring disk 33.

The lighter phase LP flows radially inwards in the drum 3 in the separation chamber and rises upwards through a channel 38 on a shaft of the distributor. There, the phase LP leaves the drum according to FIGS. 1 and 2 at a radius ro.

The control valve(s) 36, 39 can be used to easily influence the separation process. This results in an optimization of the separation process.

The main application of the process for operating the separator is cell separation in the pharmaceutical industry. The capacity range is intended for processing broths from fermenters in the 100 I-4000 I range as well as for laboratory applications.

Other areas of industry in which separators are used are also conceivable: Chemicals, pharmaceuticals, dairy technology, renewable raw materials, oil and gas, beverage technology, mineral oil, etc.

The separators shown enable the production of a separator insert in which preferably all components that come into contact with the product can be made of plastic or other non-magnetic materials that can be disposed of after a single use or fed into a recycling process. This eliminates the need for cleaning after use. The separator and its operation can therefore be implemented cost-effectively.

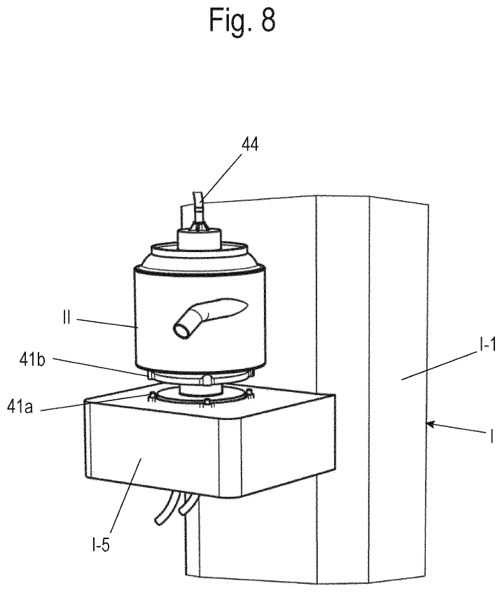

FIG. 8 shows a modification of the separator insert II of FIGS. 1-7 in a second embodiment variant, wherein identical features are provided with analogous reference signs. The special feature of this second embodiment variant is that the positive locking means 41a and the corresponding positive locking means 41b provided on the frame I are only provided on one side between the frame I and the separator insert II, thereby also enabling axial and torsional locking of the separator insert II relative to the frame I. Among other things, this reduces the complexity of the structure.

The use of the modular centrifugal separator with interchangeable separator insert shown in FIG. 1-8 ensures a sterile interior, i.e., a sterile flow path within the centrifugal separator.

Suitably, other interchangeable components can also be used in separators with a product feed and discharge system consisting of separator insert, feed system and discharge system in order to provide a sterile flow path for the feed suspension and the separated light and heavy phases. The optional discharge system as part of the product discharge system is also designed accordingly.

Mentioned purely as examples, the pump for the feed suspension, the hose line for the feed, the hose lines for the light phase and the heavy phase and the receiving container for the heavy phase can be interchangeable sterile components that are suitably used to separate a single product batch or a limited number of product batches. The hose line for the drainage liquid as well as the container for the drainage liquid can also be interchangeable sterile components. All these components are connected to each other with sterile connectors to enable simple and at the same time sterile changing of the components. The product feed system, the product discharge system and the drainage discharge system of the separator are explained in more detail below with reference to FIGS. 9a-9c:

For example, a single-use pump 101, preferably in the form of a centrifugal pump, can be used in the feed. This has the advantage that it is smaller than comparable peristaltic pumps with the same flow rate. The pump delivers a certain volume depending on its speed and the existing back pressure.

The flow meter 102, which is also arranged in the feed line between pump 101 and separator insert II, preferably works with a non-contact measuring principle, e.g., ultrasonic transit time difference method. This means that it can simply be pushed over the feed line without coming into contact with the product.

It can therefore be constantly reused, while the feed hose is a single-use product. The measuring signal from the flow meter is used to regulate the speed of the feed pump. In this way, a controller can adjust the speed of the feed pump so that the preselected setpoint for the feed volume matches the measured actual value. The pump and flow meter are arranged in the ascending feed line so that the line is always filled with liquid, resulting in a more stable measured value of the flow meter 102.

A pump 110 and a flow meter 111 are arranged in the discharge line for the heavy phase. The pump and flow meter are arranged in the ascending discharge line so that the line is always filled with liquid, which results in a more stable measured value of the flow meter 111. A flow meter 115 can also be arranged in the discharge of the light phase, e.g., in the direction of flow downstream of the peristaltic pump 107.

The drain pump 110 is preferably designed as a peristaltic pump. One of the advantages of a peristaltic pump is that it only comes into contact with the outside of the drain hose, but is not in direct contact with the product.

It can therefore be constantly reused, while the drain hose is a single-use product. Another advantage of the peristaltic pump is that it delivers a defined volume depending on the speed. Unlike the centrifugal pump, it can be used as a throttle, i.e., it can generate a pressure in the discharge of the heavy phase, the level of which can be regulated by the control unit. The pressure sensors required for this can be provided in individual or preferably all hose lines (not shown in the picture).

A container 105 is provided in the discharge line of the light phase, which serves as a buffer container. By means of a filling-level measuring device 104, the filling level of the light phase currently in the buffer tank is determined and passed on to the control unit. Alternatively, the filling level can be monitored by a limit switch, in which case the pump control options are reduced.

The light phase can be introduced from the separator insert II into the container 105 in the upper part of the container 105 (above the liquid level that is forming) or in the lower part of the container (below the liquid level that is forming). For products that tend to foam, the upper inlet has proven to be the best choice. The outlet of the container 105 is connected to a descending drain hose, which is guided by an optical sensor 106 and a peristaltic pump 107.

The speed of the pump is ideally controlled with the aid of the measuring signal from the filling-level measuring device 104 so that the container 105 is never completely full and never completely empty. This can also be achieved, for example, by arranging two limit switches to monitor the minimum and maximum levels. In this way, the drain hose is always full, resulting in a stable signal from the optical sensor 106. The signal from the optical sensor 106 is used to assess the quality of the light phase. For example, the proportion of remaining lees and suspended solids can be assessed. The pump 107 can be designed as a centrifugal pump or as a peristaltic pump. The volume of the container 105 must be selected so that the residence time of the light phase in the container is sufficiently long for bubbles to separate from the liquid. With the aid of the measured value or the measuring signals from the filling-level measuring device 104, the delivery volume of the pump 107 can be set so that a filling level is maintained approximately in the middle of the container 105. Alternatively, this can also be made possible by one or more limit switches.

The drain hose line connected to the discharge of the heavy phase of the separator insert II leads into a further container 109, which is equipped with a filling-level measuring device 108. Alternatively, one or more limit switches can also be used here. Both variants are preferably non-invasive in design. This allows the filling level of the heavy phase in the container 109 to be determined and controlled in the same way as for the light phase.

In addition, the separator insert II has an optional drainage discharge system DS, wherein the drainage liquid is collected in a drainage container 114. Drainage liquid essentially accumulates when the drum comes to a standstill at the end of batch processing and runs empty via this discharge.

All hose lines in FIG. 9a for supply and drainage lines into and out of the separator system then each lead into a sterile coupling 112. Not shown in FIG. 9a is the frame for holding the separator insert and the drive.

The product feed system PZS shown in FIG. 9a, the product discharge system PAS comprising the product discharges of the heavy and light phases and an optional discharge system DS belonging to the PAS are separated from each other outside the separator insert and are therefore hermetically sealed.

A filling-level measuring device 108 or 104 is shown as an example in FIG. 9b. Here, an ultrasonic sensor element 300 is arranged below the bottom area of the container 105/109, e.g., a tank, a bottle or a bag. It emits a signal which is reflected at the liquid boundary and is received again by the ultrasonic sensor element 300. The filling level can be determined directly from the transit time of the signal.

An arrangement of two limit switches 400, which are positioned on the side of the container, is shown in FIG. 9c as an alternative variant to FIG. 9b. The limit switches detect an upper and a lower filling level. Exceeding the upper filling level is evaluated by the evaluation unit 500 and starts the respective pump 107/110. When the filling level falls below the lower filling level, the respective pump is stopped again. In this way, the filling level of the container is maintained between the lower and upper filling levels.

Alternatively, a single filling level can be detected and the respective pump can be switched on when this level is exceeded and switched off when it falls below this level. Here it may be useful to provide a certain minimum running time for the pump or to apply a hysteresis to the setpoint for the pump.

In a further embodiment variant, however, three or more limit switches 400 can also be used, which detect at least a lower S1, a middle S2, and an upper S3 level in the tank. For level control of the tank, these three level signals are combined with the measured values M1 of the flow meter 102 in the feed and M2 of the flow meter 115 in the discharge of the light phase.

If the level S1 in the tank is exceeded, the pump 107 starts in the light phase sequence. The setpoint for the pump is calculated:

$$a ) Setpoint = M 1 - M 2 - correction value$$

If the level S2 in the tank is exceeded, the setpoint for the pump is then calculated:

$$b ) Setpoint = M 1 - M 2$$

If the level continues to rise and reaches S3, the setpoint for the pump must be calculated again according to formula a) and the correction value must be increased for a while and then reduced again.

After a while, such a self-learning system has reached a stable state, so that the filling level in the container also settles at a constant value.

The evaluation in FIGS. 9b and 9c is carried out by an evaluation unit 500, which evaluates the measuring signals and thereby determines the filling level or monitors when a limit level is reached. The activation of the pumps can also be initiated by this evaluation unit.

The measuring principle of the limit switches 400 can, for example, be based on a capacitance measurement, wherein the change in the measured capacitance value is decisive for the evaluation.

FIGS. 9b and 9c also have a pressure sensor 113 for determining a position pressure, which can also be used to determine the filling level, as there is a correlation between the height of the liquid column in the container and the pressure generated by this. This measured pressure value is also evaluated by an evaluation unit, which controls the corresponding pump 107/110, for example.

FIG. 10 shows a modification of the first variant of the separator insert II of FIGS. 1-8 for connection to the discharge system of FIG. 9a. In addition to a standard product-feed line 124 and a product-discharge line 125, the separator insert II also has a drainage discharge line 120. This is arranged in the bottom area 121 of the separator insert and has a liquid discharge 122 and 123 both from the drum and from the housing. The remainder can be identical in construction to previous embodiment variants.

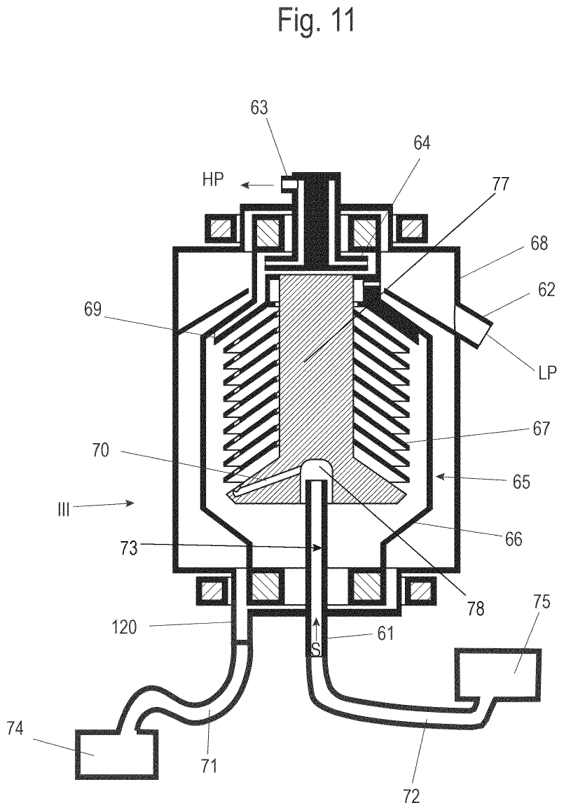

FIG. 11 shows a second variant of a separator insert III, which can be operated as part of a separation process. This separator insert III has a bottom-side feed via the feed line 61 and the distributor 70 into the disk stack 67. The product-feed line 61 comprises a feed nozzle 73, which extends from the bottom of the housing 68 into the interior of the rotor 65 and opens into a distribution chamber 78 of a holding device 77 of the disk stack 67. The holding device 77 can have a longitudinal axis that is parallel to the axis of rotation of the rotor 65. One or more distribution channels 70 extend from the distribution chamber 78, which allow radial forwarding of the supplied starting product into a separation zone of the rotor 65.

The product discharge 62 of the light phase takes place in the same way as FIGS. 1-10. The product discharge 63 of the heavy phase takes place by being drained via channels in a separating disk 69, here as a closed-walled separating disk at the end of the disk pack, and finally by a gripper 64 into a discharge through the product line of the product discharge 63. At the separating disk, a separation takes place between the heavy phase and the light phase, wherein the heavy phase is guided around the outside of the disk and the light phase is guided and discharged on the inside of the disk. However, this is only one of many possible variants of a product discharge for the heavy phase.

The separator insert III can be designed in such a way that the rotor 65, in particular the drum 66 and the disk pack 67, can be removed from the housing 68. In this variant, it is also recommended that the rotor, in particular the drum, be emptied of residual liquid before the rotor is removed as part of the present process. In this case, this can be carried out via the feed line 61.

It is then recommended that the feed line 61 is also replaced when the separator insert III is replaced so as not to expose a subsequent batch to cross-contamination. Accordingly, the feed line can be attached to the housing in a replaceable and medium-tight manner using non-presented seals, e.g., sealing sleeves.

FIG. 11 can be modified in many ways, but shows in particular that the method can also be applied to a separator in which only the rotor with its product-feed and product-discharge lines is designed as an interchangeable separator unit III.

The housing 68—not shown—can be opened, for example by forming part of the housing as a cover. For this purpose, it is preferable to remove at least the upper receptacle from the cover.

In FIG. 11, the residual liquid is drained off via the drainage discharge line 120 into a collecting container 74 via a line element 71 connected to it, in particular a drainage element in the form of an attached or plugged-on hose. The feed line 61, in particular the feed nozzle 73, is connected to a feed element 72, which is connected to a container 75 with the suspension of the starting product. A switching valve, not shown, can be arranged in this line element, which switches between two containers 75, e.g., in order to supply a demulsifier to improve the suspension. Alternatively, the valve can be closed and the line elements can be exchanged with the containers.

In addition, the feed element can have a pump, e.g., a hose squeeze pump, in which only the feed element comes into contact with the starting product.

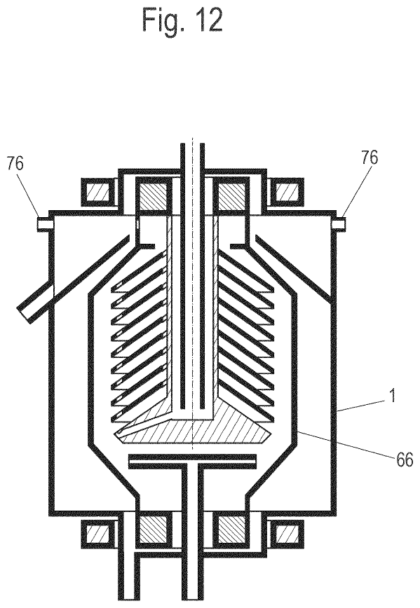

FIG. 12 shows a further variant of a separator insert II, which can be operated as part of the aforementioned separation process. This separator insert II has at least one connection piece 76 on its housing 1. The separator insert can be filled with an inert gas through this connection piece before the product to be separated enters the separator insert. In this way, the product to be separated is prevented from coming into contact with air or oxygen. A second connection piece 76 can be provided on the housing 1, which is provided for draining gases from the separator insert so that the separator insert can be flushed with inert gas.

The gas can also be extracted from the otherwise hermetically sealed separator insert through the connection piece 76 in such a way that a negative pressure is created in the separator insert, which not only reduces contact with the remaining oxygen, but also reduces the frictional power of the rotating drum 66, which now rotates in an atmosphere of lower density.

Alternatively, in addition to an inert gas, a compressed gas, e.g., compressed air, can also be introduced via one or more of the gas connections 76, which additionally facilitates the emptying of the housing via the drainage line.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

List of reference signs

| | |
|---|---|
| Frame | I |
| Bracket | I-1 |
| Carriage | I-2 |
| Rollers | I-3 |
| Receptacles | I-4, I-5 |
| Separator insert | II |
| Housing | 1 |
| Rotor | 2 |
| Drum | 3 |
| Magnetic bearing devices | 4, 5 |
| Stator units | 4a, 5a |
| Rotor unit | 4b, 5b |
| Radial boundary wall | 6, 7 |
| Product-feed line | 8 |
| Product-discharge line (light phase) | 10 |
| Feed pipe | 12 |
| Opening | 12a |
| Distributor | 13 |
| Distributor shaft | 14 |
| Distributor foot | 15 |
| Distributor channel | 16 |
| Separating disk | 17 |
| Cyl. sections | 18, 19, 20 |
| Con. sections | 18a, 20a |
| Outlets | 21 |
| Paring disk | 22 |
| Inlet openings | 22a |
| Catch ring chamber | 23 |
| Drain pipe | 24 |
| Connection piece | 24a |
| Chamber | 25 |
| Conical wall | 26 |
| Paring disk | 33 |
| Inlet openings | 33a |
| Product-discharge line (heavy phase) | 34 |
| Drain | 35 |
| Control valve | 36 |
| Control unit | 37 |
| Channel | 38 |
| Control valve | 39 |
| Drain | 40 |
| Pins | 41a |
| Recesses | 41b |
| Recesses | 42 |
| Through-opening | 43 |
| Hoses | 44, 45 |
| Centrifugal separator | 100 |
| Pump | 101 |
| Flow meter | 102 |
| Filling-level measuring device | 104 |
| Container | 105 |
| Optical sensor | 106 |
| Peristaltic pump | 107 |
| Filling-level measuring device | 108 |
| Container | 109 |
| Pump | 110 |
| Flow meter | 111 |
| Sterile coupling | 112 |
| Pressure sensor | 113 |
| Drainage container | 114 |
| Flow meter | 115 |
| Drainage discharge line | 120 |
| Floor area | 121 |
| Liquid discharge | 122 |
| Liquid discharge | 123 |
| Separating apparatus | 200 |
| Sensor element | 300 |
| Limit switch | 400 |
| Evaluation unit | 500 |
| Separator insert | III |
| Feed line | 61 |
| Product discharge (light phase) | 62 |
| Product discharge (heavy phase) | 63 |
| Gripper | 64 |
| Rotor | 65 |
| Drum | 66 |
| Disk pack | 67 |
| Housing | 68 |
| Separating disk | 69 |
| Distributor | 70 |
| Line element | 71 |
| Feed element | 72 |
| Feed nozzle | 73 |
| Collecting container | 74 |
| Container | 75 |
| Connection piece | 76 |
| Holding device | 77 |
| Distribution chamber | 78 |
| Axis of rotation | D |
| Suspension | S |
| Phases | LP, HP |
| Radii | ro, ru |
| PAS | Product discharge system |
| PZS | Product feed system |
| DS | Discharge system |

1-14. (canceled)

15. A separating apparatus, comprising:
a centrifugal separator, wherein the separating apparatus is configured to separate a suspension using the centrifugal separator to reduce cross-contamination during processing of products, wherein the centrifugal separator comprises
a frame or a housing, and
a separator insert rotatably mounted relative to the frame or housing as a pre-assembled, interchangeable unit, wherein the separator insert comprises
a rotor rotatable about an axis of rotation with a drum and a drum wall;
at least one product-feed line; and
at least one product-discharge line, wherein product-contacting areas of the separator insert are partially or completely made of plastic;
at least one container connected to at least one product-discharge line; and
at least one of
a filling-level measuring device configured to determine a liquid level of the suspension within the at least one container; and
at least one limit switch configured to detect the liquid level of the suspension within the at least one container.

16. The separating apparatus of claim 15, wherein the filling-level measuring device or the at least one limit switch is arranged non-invasively on the at least one container.

17. The separating apparatus of claim 15, wherein the at least one container has a drain configured to continuously drain liquid.

18. The separating apparatus of claim 15, wherein the filling-level measuring device or the at least one limit switch has a sensor element configured to emit or receive an electromagnetic signal.

19. The separating apparatus of claim 18, wherein the electromagnetic signal is an ultrasonic signal, a microwave signal, or a light signal.

20. The separating apparatus of claim 15, wherein the filling-level measuring device or the at least one limit switch has a sensor element for configured to detect a change in capacitance.

21. The separating apparatus of claim 15, wherein the centrifugal separator has a drain of heavy phase and a drain of a light phase, wherein a pump is arranged in at least one of the drains of the heavy phase and light phase.

22. The separating apparatus of claim 21, further comprising:
a device configured to adjust discharge volume from the at least one container,
wherein the pump and the filling-level measuring device or the at least one limit switch are part of the device configured to adjust the discharge volume such that the pump is adjustable based on measuring signals from the filling-level measuring device or the at least one limit switch.

23. The separating apparatus of claim 15, wherein the filling-level measuring device is configured to continuously determine the liquid level.

24. The separating apparatus of claim 15, wherein the filling-level measuring device or the at least one limit switch is arranged interchangeably on the at least one container.

25. The separating apparatus of claim 15, wherein the filling-level measuring device is arranged on the at least one container in such a way that a signal is introducible perpendicular to the liquid level.

26. The separating apparatus of claim 15, wherein the at least one limit switch comprises a first limit switch configured to detect a lower filling level of the at least one container and a second limit switch configured to detect an upper filling level in the at least one container.

27. The separating apparatus of claim 22, wherein the device configured to adjust the discharge volume has a pressure sensor configured to determine a positional pressure of liquid in the at least one container.

28. The separating apparatus of claim 15, further comprising:
an evaluation unit configured to continuously determine the liquid level.

29. The separating apparatus of claim 15, wherein all product-feed lines are part of a feed system, all product-discharge lines are part of a discharge system, and an entirety of the separator insert, with its feed and discharge system, has a sealed design with respect to the frame or housing.

30. The separating apparatus of claim 15, further comprising:
separating means arranged in the drum.
